(19) United States
(12) Patent Application Publication
(10) Pub. No.: US 2009/0079116 A1
(43) Pub. Date: Mar. 26, 2009

(54) Vibration damping device and method of manufacturing the same

(75) Inventors: Noriaki Yoshii, Nagoya-shi (JP); Satoki Nakamura, Novi, MI (US)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/230,850

(22) Filed: Sep. 5, 2008

(30) Foreign Application Priority Data
Sep. 21, 2007 (JP) 2007-246065

(51) Int. Cl. F16F 13/04

(52) U.S. Cl. 267/140.13; 29/428

(57) ABSTRACT

A vibration damping device wherein a first stopper portion is disposed at an opening of a tubular portion of a bracket member to jut out over the opening; a second stopper portion of portal shape is disposed bridging the first opening of the tubular portion at a location axially outward from a first stopper portion; a main unit is inserted into another opening of the tubular portion; a separate stopper is juxtaposed against a first mounting member, incorporated as part of a stopper mechanism for limiting a relative displacement between the first and second mounting members in bound and rebound directions through contact with the first and second stopper portions; mounting holes perforate the first mounting member and the separate stopper; and a fixing bolt for fixing the first mounting member and the separate stopper is fixed at a location away from the mounting holes. A method of manufacturing the same is also disclosed.

### INCORPORATED BY REFERENCE

The disclosure of Japanese Patent Application No. 2007-246065 filed on Sep. 21, 2007 including the specification, drawings and abstract is incorporated herein by reference in its entirety.

### BACKGROUND OF THE INVENTION

1. Field of the Invention

The present invention relates to a vibration damping device for installation between components making up a vibration transmission system, in order to provide vibration damped connection and/or vibration damping damped support between the components, and to a method for manufacturing the same. In particular, the present invention is concerned with a vibration damping device furnished with a vibration damping main unit and with a bracket member attached thereto, and to a method for manufacturing the same.

2. Description of the Related Art

One type of known vibration damping connecting body or vibration damping supporting body for installation between components that make up a vibration transmission system is a vibration damping device having a structure which includes a first mounting member and a second mounting member positioned spaced apart from one another and linked together by a main rubber elastic body. Also known is a bracket-equipped vibration damping device which has a separate bracket attached to the second mounting member so that the second mounting member may be attached via the bracket to a component to be damped, and which is employed as an automotive engine mount, for example.

In vibration damping devices of this kind, the first mounting member and the second mounting member are induced to undergo relative displacement in the direction of moving closer to one another and the direction of moving away from each other in the axial direction, which is also the direction of principal load input. However, if the first mounting member and second mounting member experience large relative displacement due to excessive load input, there is a risk of adverse effects on the durability of the device, such as cracks forming in the main rubber elastic body for example.

Accordingly, in relation to bracket-equipped vibration damping devices it has been proposed, for example in U.S. Pat. No. 5,775,666, to provide the device with a stopper mechanism wherein a stopper fitting is disposed on the bracket, utilizing contact between the stopper fitting and a stopper portion disposed on the first mounting member to limit relative displacement of the first mounting member and the second mounting member in the axial direction, in other words, the direction of moving closer to each other and the direction of moving away from each other.

In the vibration damping device proposed in the above-mentioned U.S. Pat. No. 5,775,666, relative displacement of the first mounting member and the second mounting member in the direction away from each other is limited through contact of the stopper fitting and the stopper portion disposed on the first mounting member, while relative displacement the direction closer to each other is limited by utilizing contact of the stopper fitting against the power unit, which is fastened to the first mounting member.

However, where the structure of the device is one that does not allow the power unit to contact the stopper fitting in the axial direction, such as a structure in which the power unit is attached to the first mounting member so as to sandwich it from both sides in the axis-perpendicular direction for example, in some instance the stopper mechanism may pose an obstacle to assembly of the vibration damping device main unit and the bracket.

Specifically, in order to limit relative displacement of the first mounting member and the second mounting member in the axial direction, it will be necessary to provide, at either side of the stopper portion in the axial direction, a stopper fitting that is designed to contact the stopper portion. However, in cases where, for example, the vibration damping device main unit is attached to the bracket with the second mounting member in a force fit within the bracket, the assembly procedure will be complicated due to interference between the stopper portion and the stopper fitting, of which contact with each other in the axial direction is predicated.

### SUMMARY OF THE INVENTION

It is therefore one object of this invention to provide a fluid filled type vibration damping device of novel construction which is able to consistently limit relative displacement of the first mounting member and the second mounting member in both the direction closer to each other and the direction away from each other, and which affords ease of fitting of the vibration damping device main unit into the bracket member, as well as a method for manufacturing the device.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

One aspect of the present invention provides a vibration damping device including: a vibration damping device main unit having a first mounting member fixable to a first component of a vibration transmission system, and a second mounting member of tubular shape, the first mounting member being positioned spaced apart from an opening at a first axial end of the second mounting member with the first mounting member and the second mounting member connected by a main rubber elastic body; and a bracket member having a tubular portion fixable to another component of the vibration transmission system, the vibration damping device main unit being fixed to the bracket member by fitting the second mounting member into the tubular portion so that the second mounting member is mounted onto the other component of the vibration transmission system via the bracket member; a first stopper portion disposed at a first opening of the tubular portion of the bracket member so as to jut out over the first opening; a second stopper portion of portal shape disposed bridging the first opening of the tubular portion at a location outward in an axial direction from the first stopper portion; the vibration damping device main unit being inserted into another opening of the tubular portion of the bracket member; a separate stopper juxtaposed against the first mounting member, the separate stopper being incorporated as part of a stopper mechanism for limiting an amount of relative displacement of the first mounting member with respect to the second mounting member in a bound direction and a rebound direction through contact with the first stopper portion and with the second stopper portion; mounting holes extending in a perpendicular direction to a center axis of the tubular portion of the bracket member, while perforating the first mounting member and the separate stopper, respectively; and a fixing bolt for fixing the first mounting member and the separate stopper together being fastened and fixed at a location away from the mounting holes.

In such a vibration damping device having the structure according to the present invention, the stopper mechanism for limiting relative displacement of the first mounting member and the second mounting member in the bound and rebound directions incorporates a separate stopper which is attached to the first mounting member, and the use of this separate stopper affords easy attachment of the vibration damping device main unit to the bracket member through insertion into the tubular portion, as well as affording the desired stopper functionality in the bound direction and rebound direction. For this reason, a vibration damping device endowed with improved durability through reduced stress on the main rubber elastic body can be obtained with excellent productivity through a simple assembly operation.

Moreover, the first mounting member and the separate stopper are fastened and fixed together with a fixing bolt, and the mounting hole for mounting the first mounting member onto a component of the vibration transmission system is formed at a location away from the fastening location of the fixing bolt. With this arrangement, through mounting of the first mounting member onto a component of the vibration transmission system, the first mounting member and the separate stopper are fixed at two different locations by the fixing bolt and by a bolt, rod, or other fastening member which is passed through and threaded into the mounting hole. Consequently, it will be possible to avoid the problem of, for example, the separate stopper experiencing rotation relative to the first mounting member about the fixing bolt or the mounting hole; and the stopper mechanism which incorporates the separate stopper will effectively limit relative displacement of the first mounting member and the second mounting member.

While it is acceptable for the first mounting member and the separate stopper to be juxtaposed, for example, in a non-contacting state with a gap between them, in order to effectively fix the first mounting member and the separate stopper it is preferable for the first mounting member and the separate stopper to be juxtaposed in state of contact with each other. Still more preferably, the first mounting member and the separate stopper be juxtaposed in state of planar contact with each other. By disposing the first mounting member and the separate stopper in contact at their juxtaposed faces in this way, a state of unified assembly of the first mounting member and the separate stopper will be consistently achieved.

It should be noted that the bound direction refers to a direction lying in the principal load input direction and in which the first mounting member and the second mounting member are urged relatively closer to each other; while the rebound bound direction refers to a direction lying in the principal load input direction and in which the first mounting member and the second mounting member are urged relatively further away from each other.

In another preferable arrangement for the vibration damping device according to the present invention, the separate stopper has an “L” shape viewed in a direction of the center axis of the tubular portion of the bracket member; the separate stopper is juxtaposed against the first mounting member respectively in an axial direction of a center axis of the mounting hole and in an axis-perpendicular direction orthogonal to the axial direction so that the separate stopper projects out in the axial and axial-perpendicular directions from the first mounting member to form a back plate portion and a contact plate portion, respectively; the contact plate portion that has been juxtaposed in the axis-perpendicular direction against the first mounting member is positioned in opposition to and spaced outward in a direction of the center axis of the tubular portion of the bracket member with respect to the first stopper portion of the bracket member so that the stopper mechanism in the bound direction is constituted through contact of the contact plate portion of the separate stopper and the first stopper portion of the bracket member.

By employing such a structure in which the “L” shaped separate stopper is juxtaposed against the first mounting member respectively in the direction of the center axis of the mounting hole and in an axis-perpendicular direction perpendicular thereto, the separate stopper may be attached to the first mounting member in a more stable manner. Consequently, despite the bound direction stopper mechanism being constituted through contact of the separate stopper projecting section with the first stopper portion of the bracket member, displacement of the separate stopper with respect to the first mounting member will be prevented sufficiently so stable stopper action can be obtained.

Furthermore, in another preferred form of the vibration damping device according to the present invention, a separate rubber cover is attached to the first mounting member and the separate stopper so as to integrally cover both of the first mounting member and the separate stopper so that the first mounting member and the separate stopper come into elastic contact against the first stopper portion and the second stopper portion via the rubber cover.

The separate rubber cover covers the first mounting member and the separate stopper in this way, and the first mounting member and the separate stopper come into cushioned contact against the first stopper portion and the second stopper portion via this rubber cover. These arrangements make it possible to effectively reduce striking noise and vibration produced by the first mounting member and the separate stopper coming into contact against the first stopper portion and the second stopper portion.

Furthermore, in another preferred form of the vibration damping device according to the present invention, at least a part of a contact face of the first mounting member and the separate stopper against the second stopper portion define a sloping contact face that is sloped with respect to a contact face of the second stopper portion.

By providing such a sloping contact face defined by at least a part of the contact face of the first mounting member and the separate stopper against the second stopper portion, it will be possible to achieve effective stopper action through contact of the first mounting member and the separate stopper against the second stopper portion, even in instances where the load input direction is inclined with respect to the direction forming a right angle with the contact face on the second stopper portion.

Moreover, in another preferred practice, the sloping contact face is defined by at least part of the outside peripheral edge of the contact face of the first mounting member and the separate stopper against the second stopper portion. Also, the sloping contact face will preferably slope so that the distance separating the contact face of the first mounting member and the separate stopper and the contact face of the second stopper portion increases gradually going from the center towards the outside peripheral side of the contact face of the first mounting member and the separate stopper.

Furthermore, in conjunction with the rubber cover discussed previously, by employing as the contact face of the rubber cover against the second stopper portion a sloping face that corresponds to the sloping contact face of the first mounting member and the separate stopper, it will be possible to achieve a cushioned stopper effect through gradual progressive change in contact surface areas as the first mounting member and the separate stopper come into contact with the second stopper portion, thus further reducing striking noise and vibration produced by contact.

Further, in another preferred form of the vibration damping device according to the present invention, the first mounting member and the separate stopper are clamped from either side in a direction of juxtaposition of the first mounting member and the separate stopper (106) by the first component of the vibration transmission system; and the first component of the vibration transmission system, the first mounting member and the separate stopper are fastened in the direction of juxtaposition by a mounting bolt passed through the mounting holes of the first mounting member and the separate stopper (106).

With the first mounting member and the separate stopper wedged in the direction of their juxtaposition by the first component of a vibration transmission system in this way, the first mounting member and the separate stopper are retained in their assembled state. Furthermore, by fastening them by passing a mounting bolt through the mounting hole of the first mounting member and the separate stopper, stable fixation of the first mounting member and the separate stopper are afforded by the fixing bolt and the mounting bolt situated at mutually different locations.

In another acceptable arrangement for the vibration damping device according to the present invention, the vibration damping device main unit including: a flexible film covering an opening of the second mounting member on a side thereof opposite from the main rubber elastic body to form a pressure-receiving chamber whose wall is partially defined by the main rubber elastic body on one side of a partition member supported by the second mounting member, and an equilibrium chamber whose wall is partially defined by the flexible film on another side; a non-compressible fluid filling these two chambers; and an orifice passage through which the pressure-receiving chamber and the equilibrium chamber communicate with each other.

The present invention is advantageously implemented in cases where the vibration damping device main unit has a structure of this kind utilizing vibration damping action based on flow action of a non-compressible fluid filling the interior. In particular, even where the main rubber elastic body employs such a structure which owing to the pressure-receiving chamber and the equilibrium chamber being accommodated internally therein tends to be thin-walled, durability of the main rubber elastic body will be effectively ensured nevertheless by the stopper mechanism in the bound and rebound directions.

Further, in another preferred form of the vibration damping device according to the present invention, the vibration damping device main unit is inserted from the other opening of the tubular portion of the bracket member so that the separate stopper is attached to the first mounting member which has been positioned inserted within the second stopper portion and projecting axially outward from the tubular portion of the bracket member, so as to be juxtaposed thereon in a direction perpendicular to the center axis of the tubular portion of the bracket member from a first opening side of the second stopper portion.

With this arrangement, the vibration damping device main unit, through force fit within the tubular portion from the other opening, can easily be attached to the bracket member on which the second stopper portion is disposed bridging the first opening of the tubular portion; and utilizing the portal shaped second stopper portion, the separate stopper can be attached to the first mounting member in a direction perpendicular to the center axis of the tubular portion, so that the stopper mechanism in the bound and rebound directions may be easily constituted.

Another aspect of the present invention provides a method for manufacturing the vibration damping device according to any one of the above forms, the method comprising: the method comprising: a vibration damping device main unit preparation step in which the vibration damping device main unit is prepared; a bracket member preparation step in which the bracket member is prepared; a bracket assembly step in which the vibration damping device main unit is inserted into the tubular portion of the bracket member from the opening thereof on the side opposite the side where the first and second stopper portions are disposed, and the vibration damping device main unit is attached to the bracket member to obtain a vibration damping device assembly; a separate stopper preparation step in which the separate stopper is prepared; and a separate stopper assembly step in which the separate stopper is juxtaposed against the first mounting member in the vibration damping device assembly in an axis-perpendicular direction from a first opening of the second stopper portion, and is fastened thereto with the fixing bolt.

By employing such a method for manufacturing a vibration damping device according to the present invention, it is possible to easily accomplish both attachment of the vibration damping device main unit to the bracket member, and a bound/rebound stopper mechanism utilizing the separate stopper.

In preferred practice, the method for manufacturing a vibration damping device according to the present invention further comprises: a rubber cover preparation step in which the rubber cover is prepared; and a rubber cover assembly step in which the rubber cover is fit onto the first mounting member and the separate stopper after the separate stopper has been attached to the first mounting member.

A vibration damping device having a rubber cover installed can be obtained by providing this rubber cover preparation step and rubber cover assembly step.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a vertical cross sectional view of a vibration damping device in the form of an engine mount of construction according to one preferred embodiment of the present invention, taken along line 1-1 of FIG. 3;

FIG. 2 is a front elevational view of the engine mount of FIG. 1;

FIG. 3 is a top plane view of the engine mount of FIG. 1;

FIG. 4 is a front elevational view of a first mounting member of the engine mount of FIG. 1;

FIG. 5 is a side elevational view of the first mounting member of FIG. 4;

FIG. 6 is a top plane view of the first mounting member of FIG. 4;

FIG. 7 is a perspective view of the first mounting member of FIG. 4;

FIG. 8 is a front elevational view of a separate stopper of the engine mount of FIG. 1;

FIG. 9 is a top plane view of the separate stopper of FIG. 8;

FIG. 10 is a perspective view of the separate stopper of FIG. 8;

FIG. 11 is a front elevational view of the first mounting member and the separate stopper which are assembled together;

FIG. 12 is a top plane view of the first mounting member and the separate stopper assembled together of FIG. 11;

FIG. 13 is a perspective view of the first mounting member and the separate stopper assembled together of FIG. 11;

FIG. 14 is view suitable for explaining the first mounting member and the separate stopper assembled together within the engine mount of FIG. 1;

FIG. 15 is a front elevational view of a rubber cushioning member of the engine mount of FIG. 1;

FIG. 16 is a bottom plane view of the rubber cushioning member of FIG. 15; and

FIG. 17 is a cross sectional view taken along line 17-17 of FIG. 16.

### DETAILED DESCRIPTION OF PREFERRED EMBODIMENTS

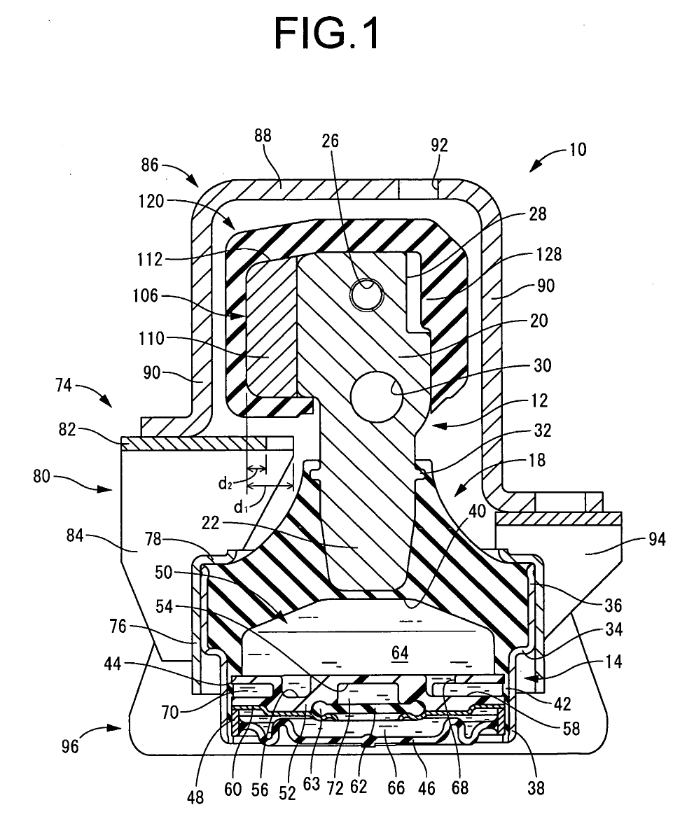

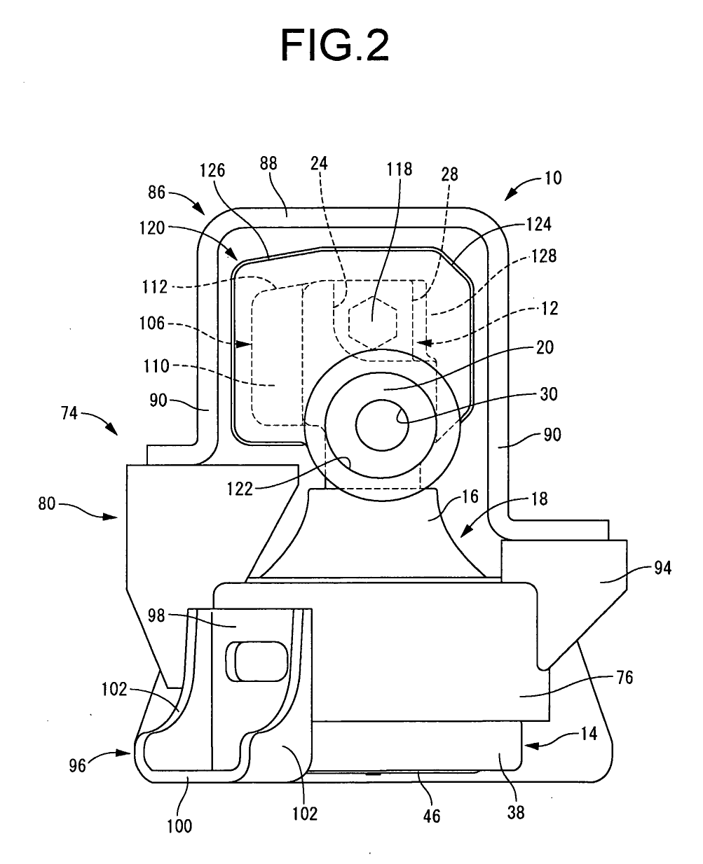

Referring first to FIGS. 1 to 3, there is illustrated an automotive engine mount 10 as a first embodiment of a vibration damping device according to the present invention. This engine mount 10 has an vibration damping device main unit in the form of a mount main unit 18 of a structure in which a first mounting member 12 of metal and a second mounting member 14 of metal are connected to each other by a main rubber elastic body 16. Herein, the vertical direction refers to the principal vibration input direction with the engine mount 10 installed on a vehicle; it refers also the vertical direction in FIG. 1, which is also the axial direction of the engine mount 10.

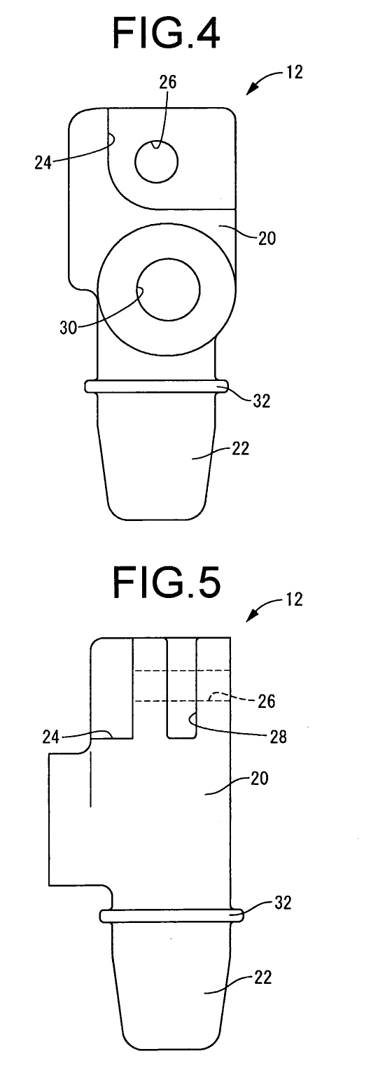

To describe in detail, the first mounting member 12 is a highly rigid member made of iron, aluminum alloy, or other metal material; as depicted in FIGS. 4 to 7, its structure integrally incorporates a mounting portion 20 and an anchor portion 22. The first mounting member 12 is adapted for mounting on the one of the components making up a vibration transmission system, specifically, the power unit of an automobile.

As depicted in FIG. 4, the mounting portion 20 has a block shape with chamfered edge. An escape portion 24 defined by indented contours which open onto the front face, top end face, and one side face (the right side face in FIG. 4) is formed at the upper end of the mounting portion 20. A circular fixing hole 26 extending in the sideways direction in FIG. 5 is formed perforating the escape portion 24.

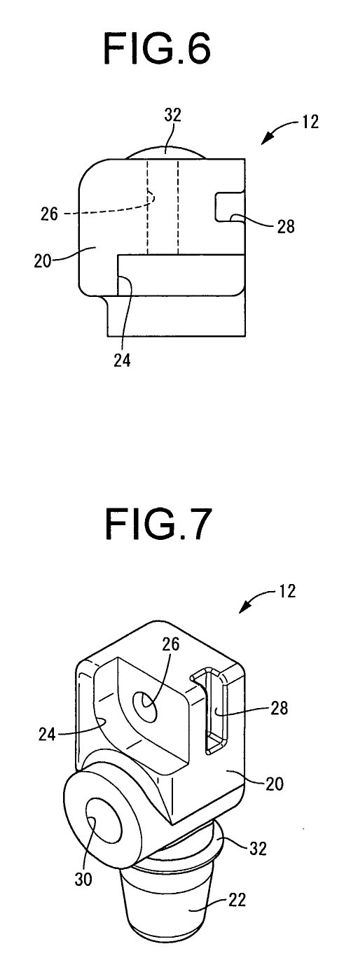

An indented guide slot 28 is formed at the right end of the mounting portion 20 in front view. The guide slot 28 extends for a prescribed length into the axially medial section of the mounting portion 20 with generally unchanging cross section in the axial direction, and in front view opens onto the upper end face and the right side face of the mounting portion 20. As depicted in FIG. 6, the guide slot 28 is formed towards the back face side from the escape portion 24 to a depth not extending as far as the fixing hole 26.

The lower end of the mounting portion 20 projects out with generally unchanging cross section towards the front face (the left side in FIG. 5), and the center of this projection section is perforated by a mounting hole 30 that extends in the mount axis-perpendicular direction, which is the sideways direction in FIG. 6.

The anchor portion 22 has a circular block shape and extends downward from the mounting portion 20. In this embodiment, the basal end section of the anchor portion 22 extending out from the mounting portion 20 (the upper end section in FIG. 4) extends with unchanging cross section, while the distal end section (the lower end section in FIG. 4) gradually decreases in diameter towards the lower end. Additionally, an annular flange portion 32 that flares peripherally outward in the axis-perpendicular direction is integrally formed in the axially medial section of the aforementioned basal end section. The circular projecting section mentioned above is formed at the border of the mounting portion 20 and the anchor portion 22.

Meanwhile, as depicted inter alia in FIG. 1, the second mounting member 14 has a thin-walled, large-diameter, generally round tubular shape, and like the first mounting member 12 is a highly rigid member made of iron, aluminum alloy, or other metal material. An annular shoulder portion 34 is formed in the axially medial section of the second mounting member 14, with the section axially above the shoulder portion 34 defining a large-diameter tube portion 36 and the section axially below the shoulder portion 34 defining a small-diameter tube portion 38 that is smaller in diameter than the large-diameter tube portion 36.

The first mounting member 12 and the second mounting member 14 are positioned with the first mounting member 12 spaced apart to the side of a first opening in the axial direction of the second mounting member 14. The first mounting member 12 and the second mounting member 14 are elastically linked through the main rubber elastic body 16.

The main rubber elastic body 16 is a rubber elastic body having a thick-walled, large-diameter, generally frustoconical shape; the anchor portion 22 of the first mounting member 12 is inserted into and vulcanization bonded to its small-diameter end, while the large-diameter tube portion 36 of the second mounting member 14 is juxtaposed against and vulcanization bonded to the outside peripheral face of its large-diameter end. The opening at the first axial end of the second mounting member 14 is thereby provided with fluid-tight closure by the main rubber elastic body 16. As will be appreciated from the description above, in this embodiment the main rubber elastic body 16 is constituted as an integrally vulcanization molded component incorporating the first mounting member 12 and the second mounting member 14.

A circular recess 40 of inverted conical bowl shape opening onto the axial lower end face is formed in the main rubber elastic body 16 at its at the large-diameter end. A rubber seal layer 42 is formed along the rim of the opening of the circular recess 40. This rubber seal layer 42 has a thin-walled, large-diameter, generally round tubular shape and is integrally formed with the main rubber elastic body 16 so as to extend downward from the outside peripheral face at the lower end of the main rubber elastic body 16. The outside peripheral face of the rubber seal layer 42 is vulcanization bonded to the inside peripheral face of the small-diameter tube portion 38 of the second mounting member 14, and the inside peripheral face of the small-diameter tube portion 38 is covered substantially in its entirety by the rubber seal layer 42. The rubber seal layer 42 has an annular shoulder 44 on its inside peripheral face in the axially medial section, with the section situated axially below the shoulder 44 being thinner than the section situated axially above.

A diaphragm 46 constituting the flexible film is disposed on the opening at the other axial end of the second mounting member 14. The diaphragm 46 is formed by a rubber elastic body of thin, generally disk shape endowed at its outside edge portion with a sufficient level of slack and adapted to readily allow elastic deformation. An annular fastener fitting 48 is vulcanization bonded to the diaphragm 46 at its outside edge portion. That is, the diaphragm 46 according to this embodiment is constituted as an integrally vulcanization molded component incorporating the fastener fitting 48.

The integrally vulcanization molded component of the diaphragm 46 is assembled together with the integrally vulcanization molded component of the main rubber elastic body 16. Specifically, the fastener fitting 48 which is part of the integrally vulcanization molded component of the diaphragm 46 is inserted from the lower end opening into the small-diameter tube portion 38 of the second mounting member 14 which is part of the integrally vulcanization molded component of the main rubber elastic body 16. The second mounting member 14 is then subjected to a diameter reduction process, discussed later, to attach the integrally vulcanization molded component of the diaphragm 46 to the integrally vulcanization molded component of the main rubber elastic body 16, with the fastener fitting 48 fixed fitting into the lower end opening of the second mounting member 14.

Through attachment of the integrally vulcanization molded component of the diaphragm 46 to the integrally vulcanization molded component of the main rubber elastic body 16 in this way, the lower end opening of the second mounting member 14 is closed off fluid-tightly by the diaphragm 46. A fluid chamber 50 that is isolated from the outside and filled with a non-compressible fluid is thereby formed to the inside peripheral side of the second mounting member 14, between the axially opposed faces of the main rubber elastic body 16 and the diaphragm 46. No particular limitation is imposed on the non-compressible fluid which fills the fluid chamber 50, but preferably an alkylene glycol, a polyalkylene glycol, silicone oil, or a mixture thereof will be used. In order to effectively achieve vibration damping action based on flow action of the fluid, discussed later, it will be especially preferable to use a low-viscosity fluid of 0.1 Pa·s or lower.

A partition member 52 is positioned housed in the fluid chamber 50. The partition member 52 has a thick generally circular disk shape, and in this embodiment is made of hard synthetic resin. A circular center recess 54 is formed in the partition member 52 so as to open onto the lower end face in its diametrically center section. A shallow, bottomed annular recess is formed at the rim of the opening of the center recess 54. A slot 56 formed in the partition member 52 so as to open onto the upper end face in its diametrically center section extends for a prescribed length just short of the circumference of the center recess 54 so as to surround the perimeter of the center recess 54. While not always clear from the drawings, this slot 56 communicates with the center recess 54 through a communicating passage (not shown) which extends in the diametrical direction. A peripheral groove 58 formed in the outside peripheral edge of the partition member 52 so as to open out onto its outside peripheral face is spaced apart a predetermined distance peripherally outward from the slot 56, and extends for a prescribed distance just short of once around the circumference.

A retainer fitting 60 is attached at the lower end face of the partition member 52. The retainer fitting 60 has a thin, generally annular disk shape and is made of metal material such as iron. A shoulder is formed in the center section of the retainer fitting 60, with the side peripherally inward from the shoulder being situated lower than the side peripherally outward from the shoulder. This retainer fitting 60 is positioned with its section situated peripherally outward from the shoulder juxtaposed against the lower end face of the partition member 52, and fastened to the partition member 52 through means such as screw fastening, engagement, adhesive bonding, or the like.

A moveable rubber film 62 is positioned between the partition member 52 and the retainer fitting 60. The moveable rubber film 62 is a rubber elastic body of generally circular disk shape having generally unchanging thickness in its diametrically center section, and having integrally formed at its outside peripheral edge an annular thick portion 63 that extends with generally unchanging circular cross section about the entire circumference. The moveable rubber film 62 is attached to the partition member 52, with the peripheral edge section of the film inclusive of the annular thick portion 63 sandwiched between the rim of the opening of the center recess 54 in the partition member 52 and the inside peripheral edge of the retainer fitting 60. In this attached state, the diametrically center section of the moveable rubber film 62 is positioned between the opening of the center recess 54 of the partition member 52 and the center hole of the retainer fitting 60 so as to allow slight elastic deformation of the diametrically center section of the moveable rubber film 62 in the axial direction. In other words, the opening of the center recess 54 is closed off by the moveable rubber film 62.

The partition member 52 with the moveable rubber film 62 attached in this way is positioned housed within the fluid chamber 50 and supported by the second mounting member 14. Specifically, the partition member 52 is inserted into the second mounting member 14 from its opening on the axial lower side, and the outside peripheral edge of the upper end face of the partition member 52 is positioned in abutment from below against the shoulder 44 that has been formed in the rubber seal layer 42. The integrally vulcanization molded component of the diaphragm 46 is then inserted into the second mounting member 14 from below the partition member 52, and the fastener fitting 48 is juxtaposed from below against the outside peripheral edge of the lower end face of the retainer fitting 60. The second mounting member 14 is then subjected to a diameter reduction process such as 360-degree radial compression to reduce the diameter of the small-diameter tube portion 38 in which the partition member 52 and the fastener fitting 48 have been internally fitted, whereby the partition member 52 and the fastener fitting 48 are imposed fitting securely against the second mounting member 14 via the intervening rubber seal layer 42.

With the partition member 52 attached to the second mounting member 14, the outside peripheral face of the partition member 52 is juxtaposed fluid-tightly via the intervening rubber seal layer 42 against the inside peripheral face of the second mounting member 14, thereby dividing the fluid chamber 50 into two parts above and below the partition member 52 in the axial direction. Thereby to one side of the partition member 52 there is formed a pressure receiving chamber 64 a portion of whose wall is defined by the main rubber elastic body 16 and which is subjected to internal pressure fluctuations at times of load input, while to the other side of the partition member 52 there is formed an equilibrium chamber 66 a portion of whose wall is defined by the diaphragm 46 and which readily allows changes in volume. The pressure receiving chamber 64 and the equilibrium chamber 66 are filled with the non-compressible fluid that fills the fluid chamber 50.

Because the outside peripheral face of the partition member 52 is juxtaposed in intimate contact against the second mounting member 14 via the intervening rubber seal layer 42, the opening of the peripheral groove 58 which opens onto the outside peripheral face of the partition member 52 is closed off fluid-tightly, forming a tunnel-shaped passage. A first lengthwise end of the peripheral groove 58 communicates with the pressure receiving chamber 64 via a through-hole 68, while the other end communicates with the equilibrium chamber 66 via a through-hole, not shown. A first orifice passage 70 which extends a prescribed distance just short of once around the circumference and provides intercommunication between the pressure receiving chamber 64 and the equilibrium chamber 66 is thereby defined utilizing the peripheral groove 58. In this embodiment, the first orifice passage 70 is tuned to a low frequency band of around 10 Hz, corresponding to engine shake of the automobile.

The center recess 54 which has been formed in the partition member 52 communicates with the pressure receiving chamber 64 through the slot 56 and the aforementioned communicating passage, while substantial communication with the equilibrium chamber 66 is allowed through elastic deformation of the moveable rubber film 62. There is formed thereby a second orifice passage 72 through which the pressure receiving chamber 64 and the equilibrium chamber 66 are in substantial communication via a passage length shorter than the first orifice passage 70. The second orifice passage 72 is tuned to a higher frequency band than the first orifice passage 70. In this embodiment, it is tuned to a medium to high frequency band of between about 20 and 40 Hz, corresponding to idling vibration of the automobile.

The tuning frequency of the first and second orifice passages 70, 72 can be understood to be the resonance frequency of fluid induced to flow through the respective orifice passages 70, 72, which can be set appropriately through adjustment of the ratio of passage length and passage cross sectional area of the orifice passages 70, 72. In this embodiment, through appropriate setting of the moveable rubber film 62 thickness and free length in the diametrical direction, the moveable rubber film 62 will experience small active deformations in the resonance state at times of input of vibration of the tuning frequency band of the second orifice passage 72, whereby fluid flow through the second orifice passage 72 is produced on the basis of the liquid pressure transmitting action caused by the small deformations of the moveable rubber film 62.

Through the above design, there is constituted a fluid filled type mount main unit 18 having the fluid filled pressure receiving chamber 64 and equilibrium chamber 66, as well as the first and second orifice passages 70, 72 for intercommunication of these chambers 64, 66.

During manufacture of the mount main unit 18, firstly, the first mounting member 12 and the second mounting member 14 are prepared, then the first mounting member 12 and second mounting member 14 are positioned in the mold used to mold the main rubber elastic body 16, and the mold cavity of the mold are filled with rubber material to produce the integrally vulcanization molded component of the main rubber elastic body 16 incorporating the first mounting member 12 and the second mounting member 14. This completes the process to obtain the integrally vulcanization molded component of the main rubber elastic body in this embodiment.

Next, the mold cavity of the mold for molding the partition member 52 is filled with resin material to form the partition member 52. The separately prepared retainer fitting 60 and moveable rubber film 62 will then be attached to the partition member 52, thereby completing the process of preparing the partition member in this embodiment.

Additionally, the annular fastener fitting 48 is positioned in the mold for molding the diaphragm 46, and the mold cavity of the mold is filled with rubber material to produce the integrally vulcanization molded component of the diaphragm 46 which incorporates the fastener fitting 48. This completes the process to obtain the integrally vulcanization molded component of the flexible film in this embodiment.

Next, the prepared partition member 52 and the integrally vulcanization molded component of the diaphragm 46 is inserted sequentially from the opening on the lower side (the side opposite from the main rubber elastic body 16) of the second mounting member 14 which is part of the integrally vulcanization molded component of the main rubber elastic body 16. The second mounting member 14 is then subjected to a diameter reduction process such as 360-degree radial compression thereby attaching the partition member 52 and the integrally vulcanization molded component of the fastener fitting 48 fluid-tightly to the integrally vulcanization molded component of the main rubber elastic body 16, producing the mount main unit 18 according to the embodiment. This completes the process to prepare the vibration damping device main unit in this embodiment.

The mount main unit 18 is then fitted into a bracket member 74 of metal. This bracket member 74 has a tubular portion 76 for receiving force fit of the second mounting member 14. The tubular portion 76 has a large diameter circular tube shape overall, and has integrally formed at its upper end a contact piece 78 of inward flange shape projecting peripherally inward, for positioning purposes.

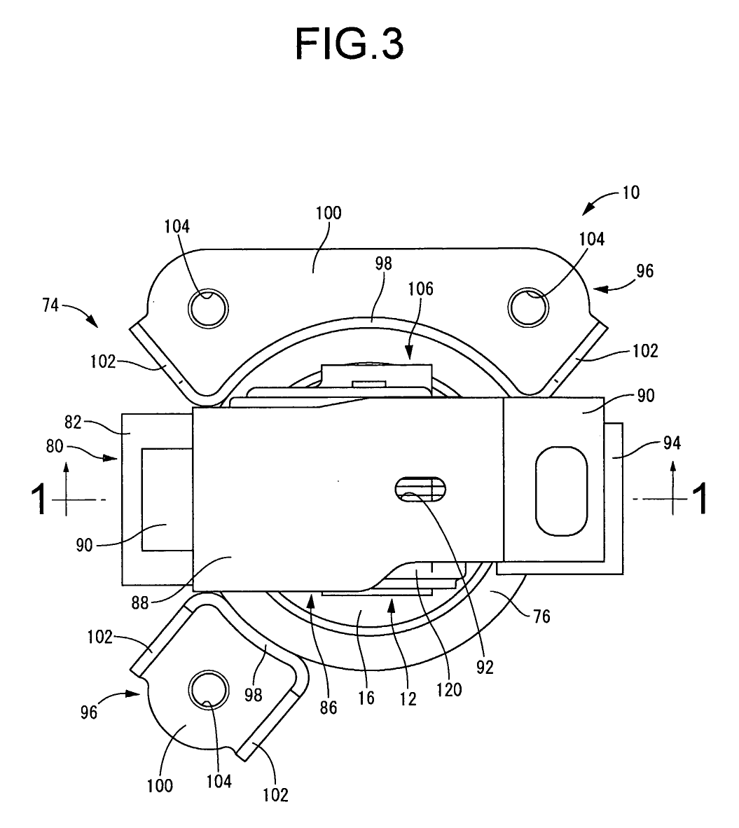

A first stopper fitting 80 constituting the first stopper portion is attached to the tubular portion 76. The first stopper fitting 80 is a highly rigid member of inverted “U” shape in side view, and integrally incorporates a first top wall portion 82, and a pair of first leg portions 84, 84 extending downward from the two ends of the first top wall portion 82 (the two ends in the direction perpendicular to the plane of the page). In this embodiment, in the first top wall portion 82 at its inward end in the axis-perpendicular direction (the right side in FIG. 1) there is formed an indentation that is situated in the vertical center section in FIG. 3, and the two ends in the vertical direction in FIG. 3 extend inwardly relative to the center portion.

The first stopper fitting 80 is fixed to the tubular portion 76 by anchoring the lower ends of the pair of first leg portions 84, 84 to the outside peripheral face of the tubular portion 76 and the contact piece 78 through means such as welds. At this point, the first top wall portion 82 of the first stopper fitting 80 projects peripherally inward beyond the contact piece 78, and the first stopper fitting 80 juts out over the opening on the axial upper side of the tubular portion 76.

Additionally, a second stopper fitting 86 constituting the second stopper portion is attached to the first stopper fitting 80. The second stopper fitting 86 is a highly rigid member of portal shape in front view, and integrally incorporates a second top wall portion 88 that extends in the axis-perpendicular direction, and a pair of second leg portions 90, 90 extending downward from the two ends thereof (the left and right ends in FIG. 1). A guide hole 92 that perforates the second top wall portion 88 with generally unchanging elliptical cross section is formed in the second top wall portion 88. During attachment of the mount main unit 18 to the bracket member 74, discussed later, this guide hole 92 is aligned relative to the guide slot 28 that was formed in the mounting portion 20 of the first mounting member 12 so at to be positioned above it in the axial direction.

Next, one of the second leg portions 90 is juxtaposed against the upper end face of the first top wall portion 82 of the first stopper fitting 80 and anchored to it through means such as welds, while the other second leg portion 90 is fastened to the tubular portion 76 via a bearing member 94 of metal.

The bearing member 94 has an inverted generally “U” shape in side view, and is fixed at its lower end to the tubular portion 76 and the contact piece 78. The bearing member 94 is disposed so as to be situated on the circumference of the tubular portion 76 at a location diametrically opposite from the section at which the first stopper fitting 80 is fixed. In this embodiment, the upper end face of the bearing member 94 is positioned below the upper end face of the first stopper fitting 80, and the pair of second leg portions 90, 90 of the second stopper fitting 86 have mutually different length in the axial direction.

With this arrangement, the portal shaped second stopper fitting 86 is attached to the tubular portion 76 so as to bridge the top of the opening at one end of the tubular portion 76 in a diametrical direction. The second stopper fitting 86 is positioned above the first stopper fitting 80, with their respective top wall portions 82, 88 situated in opposition and spaced a prescribed distance apart in the axial direction.

Meanwhile, mounting leg portions 96 are disposed on the tubular portion 76 of the bracket member 74 at multiple locations along its circumference. As shown in FIG. 3, each of the mounting leg portions 96 extends for prescribed distance in the circumferential direction and integrally incorporates an anchor plate portion 98 adapted to be anchored to the outside peripheral face of the tubular portion 76, and a fixing plate portion 100 that extends peripherally outward from the lower edge of the anchor plate portion 98. The bracket member 74 is then mounted on the vehicle body by screwing, into the vehicle body, bolts passed through bolt holes 104 that have been provided in the fixing plate portions 100. In this embodiment, reinforcing portions 102 which are generally orthogonal to both the anchor plate portion 98 and the fixing plate portion 100 are disposed at both circumferential edges of the anchor plate portion 98 and the fixing plate portion 100, with the anchor plate portion 98 and the fixing plate portion 100 being connected and reinforced by these reinforcing portions 102.

The mount main unit 18 is attached to the bracket member 74 having the above structure. Specifically, the mount main unit 18 is inserted from the lower opening into the tubular portion 76 of the bracket member 74, and the second mounting member 14 which is part of the mount main unit 18 is then forced into the tubular portion 76 to securely fit the mount main unit 18 within the bracket member 74.

With the mount main unit 18 attached to the bracket member 74, the mounting portion 20 of the first mounting member 12 inserts within the portal shaped second stopper fitting 86 and is enclosed by the second top wall portion 88 and the first leg portions 84, 84 of the second stopper fitting 86. That is, the mounting portion 20 is positioned below and spaced apart by a prescribed distance from the second top wall portion 88, and between the opposing faces of the second leg portions 90, 90 while spaced apart by a prescribed distance from each of the second leg portions 90, 90.

By fixing the second mounting member 14 to the bracket member 74 and fixing the mounting leg portions 96 of the bracket member 74 to the other component of the vibration transmission system, in this case the vehicle body, the second mounting member 14 may be mounted onto the vehicle body.

Attachment of the mount main unit 18 and the bracket member 74 may be accomplished as follows, for example.

First, the high rigidity components respectively made of iron or other material, specifically, the tubular portion 76, the first stopper fitting 80, the bearing member 94, the second stopper fitting 86, and the mounting leg portions 96, are prepared. Next, the first stopper fitting 80 and the bearing member 94 are positioned at a first opening of the tubular portion 76 and fixed to the tubular portion 76 by means such as welds. Additionally, the second leg portions 90, 90 of the second stopper fitting 86 are juxtaposed from above in the axial direction against the first stopper fitting 80 and the bearing member 94 which have been fixed to the tubular portion 76, and are respectively fixed thereto by means such as welds. The anchor plate portions 98 of the mounting leg portions 96 are juxtaposed against and fixed by means such as welds to the outside peripheral face of the tubular portion 76, at multiple locations along the circumference of the tubular portion 76. The above procedure affords the bracket member 74 according to this embodiment, and this completes the bracket preparation process in the embodiment.

The mount main unit 18 which was prepared in the vibration damping device main unit preparation step is then fitted into the prepared bracket member 74. To describe in more detail, the second mounting member 14 of the mount main unit 18 is fitted into the tubular portion 76 of the bracket member 74 from the opening at the lower end, i.e. the opening on the opposite side from the first opening where the first and second stopper fittings 80, 86 have been positioned. The mounting assembly of this embodiment composed of the mount main unit 18 and the attached bracket member 74 is constituted thereby, and this completes the bracket assembly process in the embodiment.

In this embodiment, the outside diameter of the large-diameter tube portion 36 of the second mounting member 14 is slightly larger than the inside diameter of the tubular portion 76 of the bracket member 74, and the second mounting member 14 is secured in a force fit within the bracket member 74. In this embodiment, the mount main unit 18 can be attached to the bracket member 74 at the prescribed location in the axial direction through force fit of the second mounting member 14 within the tubular portion 76 to a point that its upper edge, moving from below in the axial direction, now comes into contact against the lower end face of the contact piece 78 that has been integrally formed on the tubular portion 76 of the bracket member 74.

During attachment of the mount main unit 18 to the bracket member 74, the outside peripheral face of the first mounting member 12 (in this embodiment, the left face in FIG. 1) is positioned diametrically inward from the inside peripheral end of the first stopper fitting 80, thus making it possible for the second mounting member 14 to be inserted into the tubular portion 76 in the axial direction without interference of the mounting portion 20 of the first mounting member 12 and the first stopper fitting 80.

In this embodiment, when attaching the mount main unit 18 to the bracket member 74, it will be possible to secure the mount main unit 18 in a force fit within the bracket member 74 while these are maintained positioned relative to one another in the circumferential direction.

Specifically, in this embodiment, during fitting of the second mounting member 14 into the tubular portion 76, a guide rod (not shown) separate from the engine mount 10 is passed through the guide hole 92 which perforates the second top wall portion 88 of the second stopper fitting 86. This guide rod extends in the axial direction with a cross sectional shape corresponding to the slot cross sectional shape of the guide slot 28 that has been formed in the first mounting member 12, specifically, a chamfered generally oblong shape. The guide rod is urged axially downward by urging means, such as coil spring for example, and is displaceable axially upward when acted on by external force. The guide rod is substantially non-displaceable in the axis-perpendicular direction.

During force fit insertion of the second mounting member 14 of the mount main unit 18 into the tubular portion 76 of the bracket member 74, first, the mount main unit 18 is aligned with the bracket member 74 in the circumferential direction so that the lower end of the guide rod which has been passed through the guide hole 92 formed in the bracket member 74 can be slipped into the guide slot 28 that has been formed in the first mounting member 12.

Next, with the guide rod slipped into the guide slot 28 and the mount main unit 18 and the bracket member 74 aligned in the circumferential direction, the mount main unit 18 is forced into the bracket member 74. At this point, since guide rod is allowed to undergo displacement in the axial direction, as the mount main unit 18 is progressively forced further into the bracket member 74 the guide rod will gradually become displaced axially upward. In this way, a secure force fit of the mount main unit 18 within the bracket member 74 in the axial direction can be brought to completion while maintaining them positioned in the circumferential direction through insertion of the guide rod into the guide slot 28.

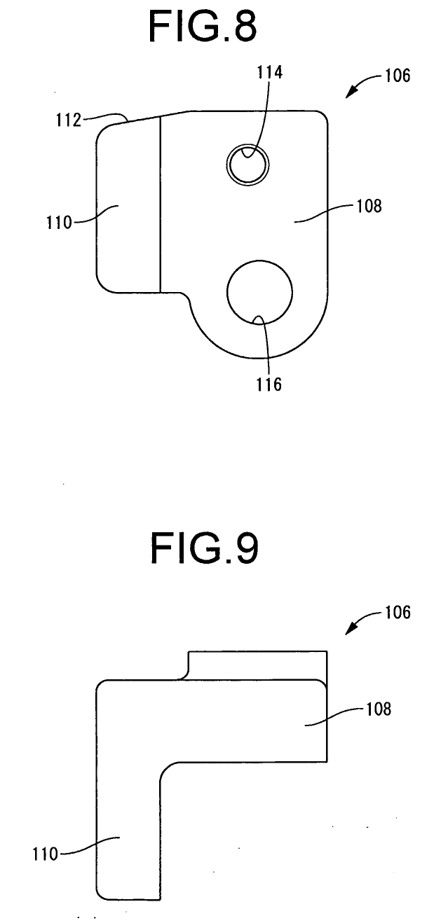

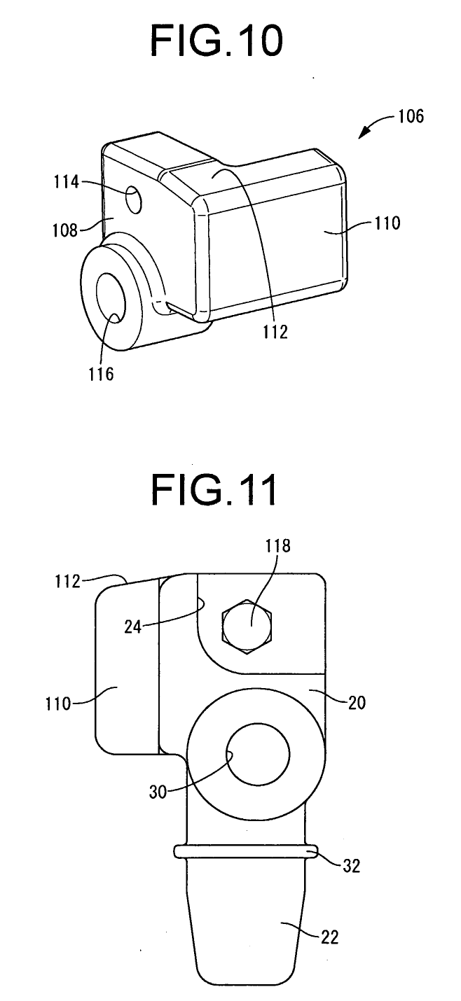

At this point, with the mount main unit 18 attached to the bracket member 74, a separate stopper 106 is mounted onto the mounting portion 20 of the first mounting member 12. As depicted in FIGS. 8 to 10, the separate stopper 106 is a high rigidity component of generally “L” shape in plan view (viewed the axial direction) made from metal material such as iron or aluminum alloy. In other words, the separate stopper 106 has a structure integrally incorporating a back plate portion 108 of thick plate shape, and a contact plate portion 110 of thick plate shape extending from the left edge of the back plate portion 108 in FIG. 8, in a direction orthogonal to the back plate portion 108.

Additionally, in this embodiment, the upper edge face of the contact plate portion 110 of the separate stopper 106 defines a sloping contact face 112 which slopes by a prescribed angle with respect to the axis-perpendicular direction, which is also the direction of extension of the second top wall portion 88 of the second stopper fitting 86. This sloping contact face 112 extends continuously to the edge on the contact plate portion 110 side from the medial portion of the separate stopper 106 in the sideways direction in FIG. 8, and slopes downward towards the outside in the axis-perpendicular direction.

Additionally, a fixing hole 114 is formed in the back plate portion 108 so as to pass through the back plate portion 108 in the thickness direction, and having a female thread on its inside peripheral face. Also, a location a prescribed distance below the fixing hole 114 is perforated by a mounting hole 116 larger in diameter than the fixing hole 114 and extending parallel to the fixing hole 114. In this embodiment, the lower end of the back plate portion 108 projects with generally unchanging circular cross section towards the side opposite the contact plate portion 110, and the mounting hole 116 is formed so as to perforate the center section of this projecting section. Also, the fixing hole 114 and the mounting hole 116 are formed at locations that, with the first mounting member 12 and the separate stopper 106 in the assembled state discussed later, respectively communicate on a straight line with the fixing hole 26 and with the mounting hole 30.

In this embodiment, the wall on the front face side of the back plate portion 108 (the lower side in FIG. 9) and the mating face of the contact plate portion 110 intended for juxtaposition against the first mounting member 12 (the right wall in FIG. 9) are both flat faces that extend parallel to the axial direction.

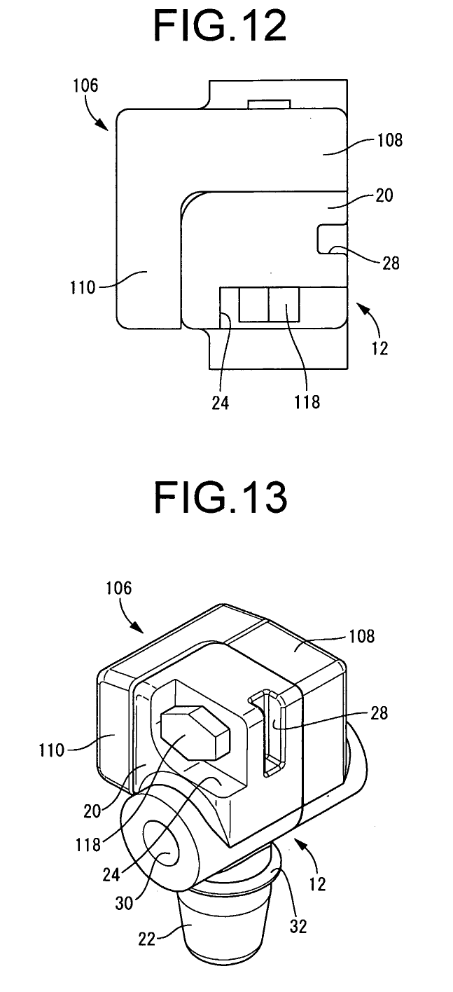

Once the mount main unit 18 has been installed in the bracket member 74, the separate stopper 106 is attached juxtaposed in the axis-perpendicular direction against the first mounting member 12 as depicted in FIGS. 11 to 14. To describe in more detail, the separate stopper 106 is inserted in the axis-perpendicular direction into the second stopper fitting 86 from the opening to one side. Then, the back plate portion 108 of the separate stopper 106 is juxtaposed against the first mounting member 12 in the direction of the center axes of the mounting holes 30, 116. The contact plate portion 110 of the separate stopper 106 is juxtaposed against the first mounting member 12 in a direction forming a right angle to the direction of the center axes of the mounting holes 30, 116. The first mounting member 12 and the separate stopper 106 are juxtaposed such that the mounting holes 30, 116 extend on a given straight line, and the fixing holes 26, 114 extend on a given straight line.

With this arrangement, the back plate portion 108 and the contact plate portion 110 of the separate stopper 106 are disposed projecting out from the outside peripheral face of the first mounting member 12 in two mutually orthogonal directions that are perpendicular to the axial direction. The contact plate portion 110 is positioned spaced apart axially above the first top wall portion 82 of the first stopper fitting 80, and spaced apart axially below the second top wall portion 88 of the second stopper fitting 86. That is, the contact plate portion 110 is positioned between the axially opposing faces of the first top wall portion 82 of the first stopper fitting 80 and the second top wall portion 88 of the second stopper fitting 86, spaced apart by prescribed distances from these top wall portions 82, 88.

As depicted in FIG. 1, in axial projection, the contact plate portion 110 and the first top wall portion 82 of the first stopper fitting 80 will overlap by d₁ in the diametrical direction (the sideways direction in FIG. 1) at the two widthwise edges of the first top wall portion 82, and by d₂ in the diametrical direction at the widthwise center of the first top wall portion 82.

The first mounting member 12 and the separate stopper 106 are juxtaposed in the axis-perpendicular direction, and a fixing bolt 118 is passed through the fixing holes 26, 114 which respectively perforate the first mounting member 12 and the separate stopper 106, fastening them to each other.

The separate stopper 106 preparation process and the process of attaching the separate stopper 106 to the first mounting member 12 will be discussed below.

First, the separate stopper 106 according to this embodiment is prepared. This separate stopper 106 can be produced, for example, by a die casting process involving filling the cavity of a mold with a metal material such as aluminum alloy and molding it to the desired shape (in this embodiment, the separate stopper 106 having generally “L” shape in plan view), or other process. This completes the separate stopper preparation process of this embodiment.

Next, the prepared separate stopper 106 is inserted in the axis-perpendicular direction into the mount assembly of the mount main unit 18 and the attached bracket member 74 from a first opening of the second stopper fitting 86, then the back plate portion 108 of the separate stopper 106 is juxtaposed against the mounting portion 20 of the first mounting member 12 from the back side in the direction of the center axis of the mounting hole 30, while the contact plate portion 110 of the separate stopper 106 is juxtaposed against the mounting portion 20 of the first mounting member 12 in a direction forming an approximately right angle to the center axis of the mounting hole 30. By so doing, the separate stopper 106 is mounted onto the first mounting member 12, with the back plate portion 108 and the contact plate portion 110 projecting out towards the back side and the left side of the first mounting member 12.

Additionally, during attachment of the separate stopper 106 to the first mounting member 12, the fixing hole 26 that has been formed in the mounting portion 20 of the first mounting member 12 is aligned on the same straight line as the fixing hole 114 that has been formed in the back plate portion 108 of the separate stopper 106, while the mounting hole 30 which has been formed in the mounting portion 20 is aligned on the same straight line as the mounting hole 116 that has been formed in the back plate portion 108.

The fixing bolt 118 will then be threaded into the fixing holes 26, 114 that have been aligned so as to communicate in series, thereby fastening the first mounting member 12 and the separate stopper 106 to one another. This completes the separate stopper assembly step of this embodiment.

In this embodiment, the inside peripheral face of the fixing hole 26 that has been formed in the mounting portion 20 is a smoothly curving surface, while the inside peripheral face of the fixing hole 114 that has been formed in the back plate portion 108 has a female thread, so that the fixing bolt 118 passes through the fixing hole 26 and screws into the fixing hole 114. The head of the fixing bolt 118 is situated above the escape portion 24 that has been formed in the first mounting member 12 and will not project outward beyond the surface on the front side of the first mounting member 12.

In this embodiment, the faces of mounting portion 20 of the first mounting member 12 for mating with the separate stopper 106 (the upper end face and the left end face in FIG. 6), as well as the faces of the separate stopper 106 for mating with the first mounting member 12, each extend approximately parallel to the axial direction and are defined by flat surfaces of negligible irregularity. Consequently, the mated faces of the first mounting member 12 and the separate stopper 106 are juxtaposed in contact with one another over substantially their entire surface, with no gaps. By positioning the first mounting member 12 and the separate stopper 106 in planar contact with one another in this way, the first mounting member 12 and the separate stopper 106 may be maintained in a stable assembled state without wobble or other problems.

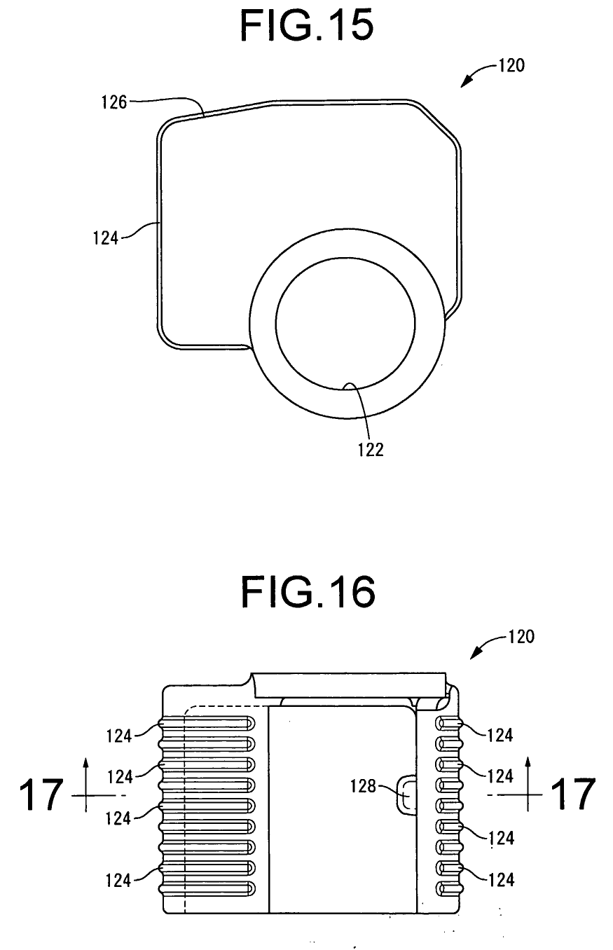

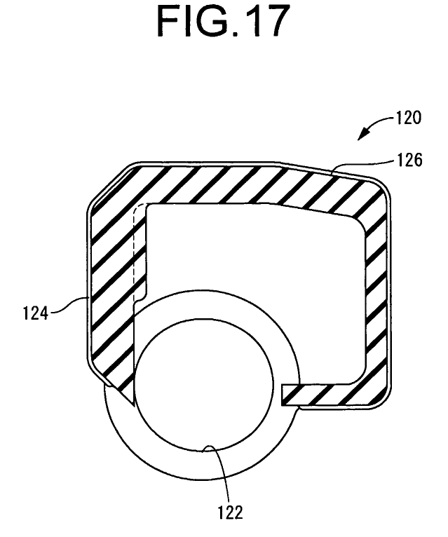

With the separate stopper 106 in this assembled state with the first mounting member 12, a rubber cushioning member 120 functioning as a rubber cover is mounted onto the separate stopper 106 and the mounting portion 20 of the first mounting member 12. As depicted in FIGS. 15 to 17, the rubber cushioning member 120 has a box-like shape with portions of the lower end face and the back face respectively removed to produce openings. In this embodiment, the lower end of the rubber cushioning member 120 juts out with a semicircular contour, and a circular mounting hole 122 is formed the lower end face of the rubber cushioning member 120 inclusive of this jutting section.

A plurality of cushioning ribs 124 are integrally formed on the surface of the rubber cushioning member 120. The cushioning ribs 124 extend with generally unchanging semicircular cross section continuously along the upper and lower end faces and the side faces (the left and right faces in FIG. 15) of the rubber cushioning member 120. In this embodiment, the plurality of cushioning ribs 124 are formed so as to extend parallel to one another.

On the upper end face of the rubber cushioning member 120, the right edge section in FIG. 17 defines a sloping face 126 that slopes progressively downward towards the right side. As will be apparent from FIG. 1, this sloping face 126 has a slope corresponding to the sloping contact face 112 of the separate stopper 106.

A catch projection 128 is integrally formed on the inside peripheral face of the rubber cushioning member 120 so as to project inward. The catch projection 128 has a projecting shape which corresponds to the guide slot 28 formed in the first mounting member 12, and is formed at the upper edge of the inside peripheral face of the left wall in FIG. 17.

The rubber cushioning member 120 according to this embodiment may be produced, for example, by filling the cavity of a mold with a rubber material and vulcanization molding it to the prescribed shape. This completes the rubber cover preparation process of this embodiment.

Then, with the separate stopper 106 mounted on the mount assembly of the mount main unit 18 and the attached bracket member 74, the prepared rubber cushioning member 120 is inserted in the generally axis-perpendicular direction into the opening at the other end (the front side) of the second stopper fitting 86, and while inducing elastic deformation the rubber cushioning member 120 is attached so as to cover the surfaces of the separate stopper 106 and the mounting portion 20 of the first mounting member 12, thereby completing the cover rubber assembly process of this embodiment.

In this embodiment in particular, the rubber cushioning member 120 can be positioned with respect to the first mounting member 12 by fitting the catch projection 128 that projects out from the inside peripheral face of the rubber cushioning member 120 into the guide slot 28 that has been formed in the first mounting member 12.

With the rubber cushioning member 120 thusly attached, the upper end face of the first mounting member 12 and of the separate stopper 106, as well as the lower end face of the contact plate portion 110 of the separate stopper 106, are covered substantially in their entirety by portions of the rubber cushioning member 120. The rubber cushioning member 120 will thereby be positioned intervening between the axially opposing faces of the first mounting member 12 and the separate stopper 106 on the one hand, and the top wall portions 82, 88 of the first and second stopper fittings 80, 86 on the other.

The outside peripheral faces at either side of the integrally assembled first mounting member 12 and separate stopper 106 in the direction of their juxtaposition are covered by the rubber cushioning member 120. Thus, the rubber cushioning member 120 is positioned intervening between the axis-perpendicular opposing faces of the first mounting member 12 and one second leg portion 90 of the second stopper fitting 86, and between the separate stopper 106 and the other second leg portion 90, respectively.

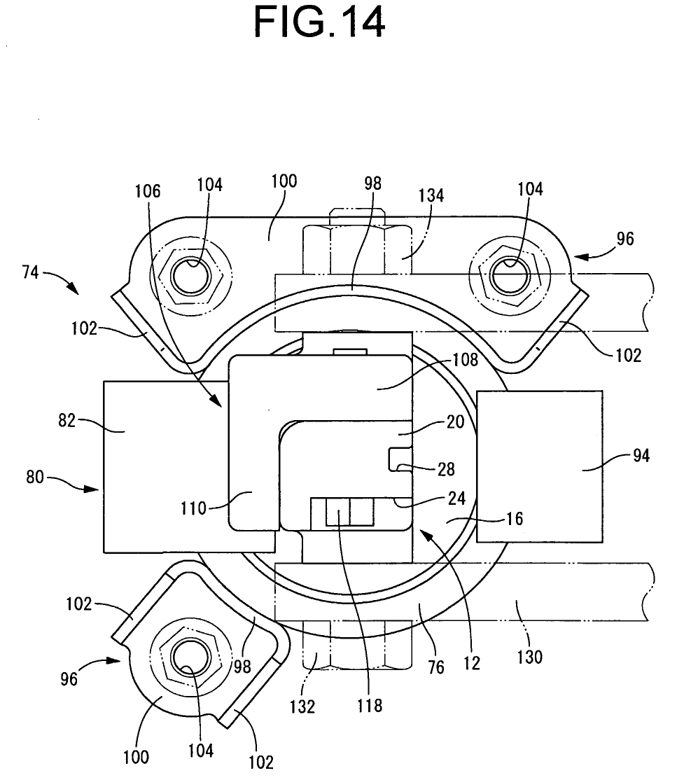

The engine mount 10 according to this embodiment having the structure described above is installed by mounting the first mounting member 12 onto the power unit side of the automobile (denoted by the double-dot and dash line in FIG. 14) while the second mounting member 14 is mounted on the vehicle body (not shown) via the intervening bracket member 74. In FIG. 14, to aid in understanding, the second stopper fitting 86 and the rubber cushioning member 120 are shown removed from the engine mount 10.

Specifically, the first mounting member 12 with the separate stopper 106 attached is clamped from either side in the direction of extension of the mounting holes 30, 116 by a support member 130 which is a component disposed on the power unit side (denoted by the double-dot and dash line in FIG. 14). The mounting holes 30, 116 of the first mounting member 12 and the separate stopper 106 are then aligned on the same line with through-holes (not shown) that have been formed in the support member 130, and a mounting bolt 132 (denoted by the double-dot and dash line in FIG. 14) is passed through these through-holes and the mounting holes 30, 116 and threaded into a nut 134. By so doing, the first mounting member 12 and the separate stopper 106 are clamped and fastened in the direction of their juxtaposition by the support member 130.

With such an automotive engine mount 10 installed in the vehicle, when vibration load is input across the first mounting member 12 and the second mounting member 14, the pressure receiving chamber 64 will experience internal pressure fluctuations, and the resultant changes in volume will give rise to a pressure differential relative to the equilibrium chamber 66, which is maintained at approximately atmospheric pressure. These relative fluctuations in pressure between the two chambers 64, 66 will give rise to fluid flow through the orifice passages 70, 72 between the pressure receiving chamber 64 and the equilibrium chamber 66, producing vibration damping action based on the flow action of the fluid.

To describe in more detail, in the event that, for example, during driving of the automobile low-frequency, large-amplitude vibration corresponding to engine shake of the automobile is input, a pressure differential will arise between the pressure receiving chamber 64 and the equilibrium chamber 66, and the fluid filling them will be positively induced to flow between the two chambers 64, 66 through the first orifice passage 70 which has been tuned a low frequency corresponding to engine shake. This fluid flow through the first orifice passage 70 will afford the desired vibration damping effect based on flow action such as the resonance action of the fluid.

In the second orifice passage 72, which has been tuned to a higher frequency band than the first orifice passage 70, since the moveable rubber film 62 that covers the opening of the second orifice passage 72 on its equilibrium chamber 66 end has been tuned to a medium to high frequency band corresponding to the tuning frequency of the second orifice passage 72, the moveable rubber film 62 will be substantially constrained at times of low-frequency, large-amplitude vibration corresponding to the tuning frequency of the first orifice passage 70. Thus, at times input of vibration in the frequency band to which the first orifice passage 70 has been tuned, the second orifice passage 72 will remain substantially obstructed so that adequate fluid flow through the first orifice passage 70 is assured.

On the other hand, in the event that, for example, with the automobile at a stop, medium to high frequency, small-amplitude vibration corresponding to idling vibration of the automobile is input, due to the pressure differential arising between the pressure receiving chamber 64 and the equilibrium chamber 66, the fluid filling them will be positively induced to flow between the two chambers 64, 66 through the second orifice passage 72 which has been tuned to medium to high frequency corresponding to idling vibration. This fluid flow through the second orifice passage 72 will afford the desired vibration damping effect based on flow action such as the resonance action of the fluid.

When vibration of the frequency band to which the second orifice passage 72 has been tuned in input, elastic deformation in the resonance state will be positively induced in the moveable rubber film 62 that has been positioned covering the opening of the second orifice passage 72 on its equilibrium chamber 66 end. The liquid pressure transmitting action arising from small deformations of the moveable rubber film 62 will place the second orifice passage 72 in a substantially communicating state, effectively producing fluid flow in the second orifice passage 72. The first orifice passage 70, which has been tuned to a lower frequency band than the second orifice passage 72, assumes a substantially obstructed state due to antiresonance action so that adequate flow of fluid through the first orifice passage 70 is advantageously assured.

In the automotive engine mount 10 of structure according to this embodiment, in the event that a large jarring load is input due to the vehicle riding over a bump etc., the first mounting member 12 and the second mounting member 14 will experience large relative displacement in the axial direction, which coincides with principal load input direction. The engine mount 10 of this embodiment herein is furnished with a stopper mechanism, and at times of input of large jarring load, relative displacement of the first mounting member 12 and the second mounting member 14 will be limited by this stopper mechanism.

To describe in more detail, when the first mounting member 12 and the second mounting member 14 experience large relative displacement in the bound direction urging them relatively closer together in the axial direction, the separate stopper 106 which has been fixed to the first mounting member 12 will be urged closer to the second mounting member 14. At this point, the first stopper fitting 80 of the bracket member 74 to which the second mounting member 14 has been fixed is positioned spaced apart by a prescribed distance axially below the separate stopper 106, and as the second mounting member 14 and the separate stopper 106 undergo relative displacement closer to one another, the separate stopper 106 and the first stopper fitting 80 will also be brought closer to one another.

Next, the separate stopper 106 will come into contact in the axial direction against the first stopper fitting 80 via part of the intervening rubber cushioning member 120, thereby limiting relative displacement in the bound direction by the first mounting member 12 to which the separate stopper 106 is fixed, and the second mounting member 14 to which the first stopper fitting 80 is fixed. The above arrangement constitutes the bound direction stopper mechanism of this embodiment.

On the other hand, when the first mounting member 12 and the second mounting member 14 experience large relative displacement in the rebound direction urging them relatively further apart in the axial direction, the separate stopper 106 which has been fixed to the first mounting member 12, in unison with the second mounting member 14, will experience displacement axially upward and away from the second mounting member 14. At this point, the second stopper fitting 86 of the bracket member 74 to which the second mounting member 14 has been fixed is positioned spaced apart by a prescribed distance axially above the first mounting member 12 and the separate stopper 106.

Thus, as the first mounting member 12 and the second mounting member 14 undergo relative displacement further apart in the axial direction, the first mounting member 12 and the separate stopper 106 will move relatively closer to the second stopper fitting 86. The upper end faces of the first mounting member 12 and the separate stopper 106 will then come into contact from below in the axial direction against the second stopper fitting 86 via the upper wall face of the rubber cushioning member 120, thereby limiting relative displacement of the first mounting member 12 and the second mounting member 14 in the rebound direction. The above arrangement constitutes the rebound direction stopper mechanism of this embodiment.

As the preceding discussion makes clear, in the engine mount 10 of structure according to this embodiment, the stopper mechanism in the bound direction is constituted through contact of the separate stopper 106 against the first stopper fitting 80, while the stopper mechanism in the rebound direction is constituted through contact of the separate stopper 106 against the second stopper fitting 86.

Moreover, the action of limiting relative displacement of the first mounting member 12 and the second mounting member 14 in the bound and rebound directions has the effect of inhibiting elastic deformation of the main rubber elastic body 16 at times of input of large jarring load, so durability of the main rubber elastic body 16 may be improved thereby.

In this embodiment, the separate stopper 106 and the first and second stopper fittings 80, 86 come into in elastic contact via the intervening rubber cushioning member 120. Thus, striking noise or shock produced by contact of the separate stopper 106 and the first and second stopper fittings 80, 86 can be ameliorated, and good ride comfort can be achieved.

Moreover, in this embodiment, cushioning ribs 124 are provided on the surface of the rubber cushioning member 120, thereby minimizing contact surface area during initial contact. This provides a higher level of cushioning at contact at the time of contact when striking noise tends to become a problem, thus making it possible to effectively eliminate striking noise.

Further, in this embodiment, the first mounting member 12 and the second leg portion 90, as well as the separate stopper 106 and the second leg portion 90, are respectively situated in opposition a prescribed distance apart. Parts of the rubber cushioning member 120 are positioned between their opposing faces. Thus, in this embodiment, an axis-perpendicular stopper mechanism for limiting relative displacement of the first mounting member 12 and the second mounting member 14 in the axis-perpendicular direction is constituted through contact of the first mounting member 12 and the separate stopper 106 with the second leg portions 90, 90 of the second stopper fitting 86.

In this embodiment, the automotive engine mount 10 furnished with both the bound stopper mechanism and the rebound stopper mechanism can be produced easily by a simple method that involves attachment in a force fit of the mount main unit 18 within the bracket member 74 which is provided at either side with the bound direction first stopper fitting 80 and the rebound direction second stopper fitting 86.

Specifically, in the engine mount 10 according to this embodiment, the first mounting member 12 is positioned peripherally inward from the first top wall portion 82 of the first stopper fitting 80 which juts out over a first opening of the tubular portion 76. Thus, when at a point in time prior to mounting of the separate stopper 106 onto the first mounting member 12, the mount main unit 18 is slipped into the bracket member 74 from the other side in the axial direction, interference (contact) between the first mounting member 12 and the first stopper fitting 80 can be avoided, and a secure force fit can be produced easily.

Moreover, after the mount main unit 18 has been installed in the bracket member 74, the separate stopper 106 is inserted from above in the axial direction from a first opening of the portal-shaped second stopper fitting 86, and is fixed to the first mounting member 12. The contact plate portion 110 of the separate stopper 106 is then positioned between the top wall portions 82, 88 of the first and second stopper fittings 80, 86, whereby the contact plate portion 110 is utilized as part of the stopper mechanisms in the bound and rebound directions.

By so doing, the openings in the axis-perpendicular direction of the second stopper fitting 86 can be utilized advantageously to facilitate the procedure for attaching the separate stopper 106 to the first mounting member 12. Consequently, the stopper mechanisms in the both the bound and rebound directions can be produced through a simple manufacturing process, without any problems from the second stopper fitting 86 which is positioned bridging the upper opening of the tubular portion.

In this embodiment, the fixing holes 26, 114 are formed so as to extend in the juxtaposition direction of the first mounting member 12 and the separate stopper 106, with the first mounting member 12 and the separate stopper 106 being fixed to one another by the fixing bolt 118 screw-fastened into the fixing hole 114. With this arrangement, the stopper load input through contact of the first mounting member 12 and the separate stopper 106 against the first and second stopper fittings 80, 86 will act on the fixing bolt 118 in the shear direction. For this reason it will be possible to avoid problems such as dislodging of the bolt, and to consistently achieve the desired stopper performance.

Furthermore, in the present embodiment, the support member 130 on the power unit side is positioned clasping the first mounting member 12 and the separate stopper 106 from either side in an axis-perpendicular direction coincident with the juxtaposition direction of the fittings 12, 106, and is fastened with the mounting bolt 132. The first mounting member 12 and the separate stopper 106 are thereby affixed assembled securely in the juxtaposition direction.

In particular, the mounting bolt 132 is passed through the first mounting member 12 and the separate stopper 106, with the first mounting member 12 and the separate stopper 106 being fastened by the mounting bolt 132, and thus the strength of assembly of the first mounting member 12 and the separate stopper 106 can be effectively reinforced.

Furthermore, as the mounting bolt 132 passes through the first mounting member 12 and the separate stopper 106 at a different location from the fixing bolt 118, even if the separate stopper 106 experiences rotational moment about the fixing bolt 118 to contact of the contact plate portion 110 with the first stopper fitting 80 and the second stopper fitting 86, the separate stopper 106 will be prevented from displacement relative to the first mounting member 12 due to the action of the rotational moment.

While the present invention has been shown herein on the basis of a preferred embodiment, it is to be understood that the present invention may be embodied with various changes, modifications and improvements which may occur to those skilled in the art, without departing from the spirit and scope of the invention.

For example, in the preceding embodiment, the bound direction stopper mechanism is composed of the separate stopper 106 and the first stopper fitting 80, while the rebound direction stopper mechanism is composed of the first mounting member 12, the separate stopper 106, and the second stopper fitting 86. However, it is not mandatory for the rebound direction stopper mechanism to include the first mounting member 12. Specifically, it would be acceptable for the rebound direction stopper mechanism to be composed of the separate stopper 106 and the second stopper fitting 86 only, for example, by designing the separate stopper 106 to project upward beyond the first mounting member 12 with the first mounting member 12 and the separate stopper 106 in the assembled state, so as to avoid contact between the first mounting member 12 and the second stopper fitting 86.

In the preceding embodiment, the bound direction stopper mechanism is composed of the contact plate portion 110 of the separate stopper 106, and the first stopper fitting 80 of the bracket member 74. However, the back plate portion 108 could also be utilized in creating the bound direction stopper mechanism, for example. As a further example, the first stopper portion could be given a structure that extends one-fourth or more around in the circumferential direction, and the bound direction stopper mechanism constituted through contact of the back plate portion 108 and the contact plate portion 110 with the first stopper portion.

It is not mandatory for the separate stopper 106 to have “L” shape viewed in the axial direction. As a specific example, it would be possible to employ a separate stopper of generally “U” shape overall viewed in the axial direction, having a plate-shaped support portion that is integrally formed on the back plate portion 108 at the edge opposite from the contact plate portion 110, and that is generally parallel with and extending in opposition to the contact plate portion 110. Since this design affords greater contact area between the first mounting member 12 and the separate stopper, it will be possible to achieve a more stable assembly with respect to input of stopper load.

As another example, the separate stopper 106 depicted in the preceding embodiment may be provided with a top wall portion integrally formed extending in the axis-perpendicular direction at the axial upper end, with this top wall portion being juxtaposed against the lower end face of the first mounting member 12. With this arrangement as well, it will be possible to achieve a more stable attachment of a separate stopper to the first mounting member 12.

In order to achieve cushioned contact of the stopper mechanism, it is preferable for the separate stopper 106 and the rubber cushioning member 120 to be furnished respectively with the sloping contact face 112 and the sloping face 126, but the sloping contact face 112 and the sloping face 126 are not essential herein. It would be acceptable, for example, to adopt a structure in which the separate stopper 106 is furnished with the sloping contact face 112 while the rubber cover is not furnished with a sloping face, with the thickness of the rubber cover changing gradually in the direction of slope of the sloping contact face 112. Furthermore, in the vibration damping device according to the present invention, the rubber cover need not be installed, and the specific structure of the rubber cover in not limited to that disclosed in the embodiment hereinabove.

The bracket member is not limited to the specific structure of the bracket member 74 shown in the embodiment herein.

While the embodiment herein shows a fluid filled mount main unit 18 utilizing vibration damping on the basis of flow action of a sealed fluid as one example of the vibration damping device according to the present invention, the vibration damping device main unit need not necessarily have a structure with a fluid filling the interior, and it is sufficient that the structure be one with a first mounting member and a second mounting member linked by a main rubber elastic body.

Additionally, whereas the embodiment herein describes the present invention embodied in an automotive engine mount 10 by way of a specific example, the invention is not limited to embodiment in an engine mount 10, and may be embodied analogously in an automotive body mount or suspension mount. Further, the vibration damping device according to the invention is not limited to automotive applications, and may be employed generally for vibration damping of vibrating bodies of various kinds.

What is claimed is:

1. A vibration damping device comprising:
a vibration damping device main unit having a first mounting member fixable to a first component of a vibration transmission system, and a second mounting member of tubular shape, the first mounting member being positioned spaced apart from an opening at a first axial end of the second mounting member with the first mounting member and the second mounting member connected by a main rubber elastic body;
a bracket member having a tubular portion fixable to another component of the vibration transmission system, the vibration damping device main unit being fixed to the bracket member by fitting the second mounting member into the tubular portion so that the second mounting member is mounted onto the other component of the vibration transmission system via the bracket member;
a first stopper portion disposed at a first opening of the tubular portion of the bracket member so as to jut out over the first opening;
a second stopper portion of portal shape disposed bridging the first opening of the tubular portion at a location outward in an axial direction from the first stopper portion;
the vibration damping device main unit being inserted into another opening of the tubular portion of the bracket member;
a separate stopper juxtaposed against the first mounting member, the separate stopper being incorporated as part of a stopper mechanism for limiting an amount of relative displacement of the first mounting member with respect to the second mounting member in a bound direction and a rebound direction through contact with the first stopper portion and with the second stopper portion;
mounting holes extending in a perpendicular direction to a center axis of the tubular portion of the bracket member, while perforating the first mounting member and the separate stopper, respectively; and
a fixing bolt for fixing the first mounting member and the separate stopper together being fastened and fixed at a location away from the mounting holes.

2. The vibration damping device according to claim 1, wherein the separate stopper has an “L” shape viewed in a direction of the center axis of the tubular portion of the bracket member; the separate stopper is juxtaposed against the first mounting member respectively in an axial direction of a center axis of the mounting hole and in an axis-perpendicular direction orthogonal to the axial direction so that the separate stopper projects out in the axial and axial-perpendicular directions from the first mounting member to form a back plate portion and a contact plate portion, respectively; the contact plate portion that has been juxtaposed in the axis-perpendicular direction against the first mounting member is positioned in opposition to and spaced outward in a direction of the center axis of the tubular portion of the bracket member with respect to the first stopper portion of the bracket member so that the stopper mechanism in the bound direction is constituted through contact of the contact plate portion of the separate stopper and the first stopper portion of the bracket member.

3. The vibration damping device according to claim 1, wherein a separate rubber cover is attached to the first mounting member and the separate stopper so as to integrally cover both of the first mounting member and the separate stopper so that the first mounting member and the separate stopper come into elastic contact against the first stopper portion and the second stopper portion via the rubber cover.

4. The vibration damping device according to claim 1, wherein at least a part of a contact face of the first mounting member and the separate stopper against the second stopper portion define a sloping contact face that is sloped with respect to a contact face of the second stopper portion.

5. The vibration damping device according to claim 1, wherein the first mounting member and the separate stopper are clamped from either side in a direction of juxtaposition of the first mounting member and the separate stopper by the first component of the vibration transmission system; and the first component of the vibration transmission system, the first mounting member and the separate stopper are fastened in the direction of juxtaposition by a mounting bolt passed through the mounting holes of the first mounting member and the separate stopper.

6. The vibration damping device according to claim 1, wherein the vibration damping device main unit including: a flexible film covering an opening of the second mounting member on a side thereof opposite from the main rubber elastic body to form a pressure-receiving chamber whose wall is partially defined by the main rubber elastic body on one side of a partition member supported by the second mounting member, and an equilibrium chamber whose wall is partially defined by the flexible film on another side; a non-compressible fluid filling these two chambers; and an orifice passage through which the pressure-receiving chamber and the equilibrium chamber communicate with each other.

7. The vibration damping device according to claim 1, wherein the vibration damping device main unit is inserted from the other opening of the tubular portion of the bracket member so that the separate stopper is attached to the first mounting member which has been positioned inserted within the second stopper portion and projecting axially outward from the tubular portion of the bracket member, so as to be juxtaposed thereon in a direction perpendicular to the center axis of the tubular portion of the bracket member from a first opening side of the second stopper portion.

8. A method of manufacturing a vibration damping device including: a vibration damping device main unit having a first mounting member fixable to a first component of a vibration transmission system, and a second mounting member of tubular shape, the first mounting member being positioned spaced apart from an opening at a first axial end of the second mounting member with the first mounting member and the second mounting member connected by a main rubber elastic body; a bracket member having a tubular portion fixable to another component of the vibration transmission system, the vibration damping device main unit being fixed to the bracket member by fitting the second mounting member into the tubular portion so that the second mounting member is mounted onto the other component of the vibration transmission system via the bracket member; a first stopper portion disposed at a first opening of the tubular portion of the bracket member so as to jut out over the first opening; a second stopper portion of portal shape disposed bridging the first opening of the tubular portion at a location outward in an axial direction from the first stopper portion; the vibration damping device main unit being inserted into another opening of the tubular portion of the bracket member; a separate stopper juxtaposed against the first mounting member, the separate stopper being incorporated as part of a stopper mechanism for limiting an amount of relative displacement of the first mounting member with respect to the second mounting member in a bound direction and a rebound direction through contact with the first stopper portion and with the second stopper portion; mounting holes extending in a perpendicular direction to a center axis of the tubular portion of the bracket member, while perforating the first mounting member and the separate stopper, respectively; and a fixing bolt for fixing the first mounting member and the separate stopper together being fastened and fixed at a location away from the mounting holes, the method comprising:
a vibration damping device main unit preparation step in which the vibration damping device main unit is prepared;
a bracket member preparation step in which the bracket member is prepared;
a bracket assembly step in which the vibration damping device main unit is inserted into the tubular portion of the bracket member from the opening thereof on the side opposite the side where the first and second stopper portions are disposed, and the vibration damping device main unit is attached to the bracket member to obtain a vibration damping device assembly;
a separate stopper preparation step in which the separate stopper is prepared; and
a separate stopper assembly step in which the separate stopper is juxtaposed against the first mounting member in the vibration damping device assembly in an axis-perpendicular direction from a first opening of the second stopper portion, and is fastened thereto with the fixing bolt.

9. The method of manufacturing the vibration damping device according to claim 8, further comprising: a rubber cover preparation step in which a rubber cover is prepared; and a rubber cover assembly step in which the rubber cover is fit onto the first mounting member and the separate stopper after the separate stopper has been attached to the first mounting member.
